(19) United States
(12) Patent Application Publication
(10) Pub. No.: US 2026/0269746 A1
(43) Pub. Date: Sep. 10, 2026

(54) SINGLE-PHASE INVERTERS WITH THREE-PHASE DROOP RESPONSE

(71) Applicant: Enphase Energy, Inc., Fremont, CA (US)

(72) Inventors: Amirhossein MOEINI, Austin, TX (US); Fernando RODRIGUEZ, Austin, TX (US); Donald Richard ZIMMANCK, Sebastopol, CA (US); Christiaan Johannes VAN ANTWERPEN, Mountain View, CA (US)

(21) Appl. No.: 19/556,555

(22) Filed: Mar. 4, 2026

Related U.S. Application Data
(60) Provisional application No. 63/767,064, filed on Mar. 5, 2025.

(51) Int. Cl. H02M 7/539

(52) U.S. Cl. CPC H02M 7/539

(57) ABSTRACT

An apparatus configured for use with a power conversion system is provided and comprises a plurality of single-phase microinverters. Each single-phase microinverter of the plurality of single-phase microinverters comprises a controller configured to independently run a three-phase droop control by decomposing a three-phase voltage to only positive sequences that are 120º apart so that the plurality of single-phase microinverters are capable of connecting to a three-phase grid.

### CROSS-REFERENCE TO RELATED APPLICATIONS

The present application claims the benefit of and priority to U.S. Provisional Application Serial No. 63/767,064, filed on Mar. 5, 2025, the entire contents of which is hereby incorporated by reference.

### BACKGROUND

### Field of the Disclosure

Embodiments of the present disclosure relate generally to power conversion systems and, in particular, to single-phase inverters with three-phase droop response.

### DESCRIPTION OF THE RELATED ART

Conventional power converters suitable for use with power conversion systems are known. The power converters (e.g., microinverter) can be three-phase, split-phase, or single-phase. For example, normally a three-phase microinverter can be used to interface to a three-phase grid. The three-phase microinverter's power output response to changes in frequency and voltage amplitude can be determined by a droop law that is programmed into the three-phase microinverter firmware. If the three-phase microinverter is grid-forming capable, then (while off-grid) the droop law will also determine the change in voltage and frequency in response to a load.

Thus, there is a need for improved single-phase inverters with three-phase droop response.

### SUMMARY

In accordance with at least some embodiments, there is provided an apparatus configured for use with a power conversion system. The apparatus comprises a plurality of single-phase microinverters. Each single-phase microinverter of the plurality of single-phase microinverters comprises a controller configured to independently run a three-phase droop control by decomposing a three-phase voltage to only positive sequences that are 120º apart so that the plurality of single-phase microinverters are capable of connecting to a three-phase grid.

In accordance with at least some embodiments, there is provided a power conversion system comprising a plurality of single-phase microinverters. Each single-phase microinverter of the plurality of single-phase microinverters comprises a controller configured to independently run a three-phase droop control by decomposing a three-phase voltage to only positive sequences that are 120º apart so that the plurality of single-phase microinverters are capable of connecting to a three-phase grid.

In accordance with at least some embodiments, there is provided a method of controlling an apparatus configured for use with a power conversion system. The method comprises independently running a three-phase droop control by decomposing a three-phase voltage to only positive sequences that are 120º apart so that a plurality of single-phase microinverters are capable of connecting to a three-phase grid.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a diagram of a power conversion system comprising a switched mode power converter, in accordance with embodiments of the present disclosure;

FIGS. 2A and 2B are block diagrams of a three-phase droop response configured for use with single-phase inverters, in accordance with embodiments of the present disclosure; and

FIG. 3 is a flowchart of a method, in accordance with embodiments of the present disclosure.

### DETAILED DESCRIPTION

Embodiments of the present disclosure are directed to improved single-phase inverters with three-phase droop response. For example, an apparatus configured for use with a power conversion system can comprise a plurality of single-phase microinverters. Each single-phase microinverter of the plurality of single-phase microinverters comprises a controller configured to independently run a three-phase droop control by decomposing a three-phase voltage to only positive sequences that are 120º apart so that the plurality of single-phase microinverters are capable of connecting to a three-phase grid. Unlike conventional single-phase microinverters. the single-phase microinverters are capable of operating on-grid and off-grid.

The foregoing description of embodiments of the disclosure comprises a number of elements, devices, circuits and/or assemblies that perform various functions as described. These elements, devices, circuits, and/or assemblies are exemplary implementations of means for performing their respectively described functions.

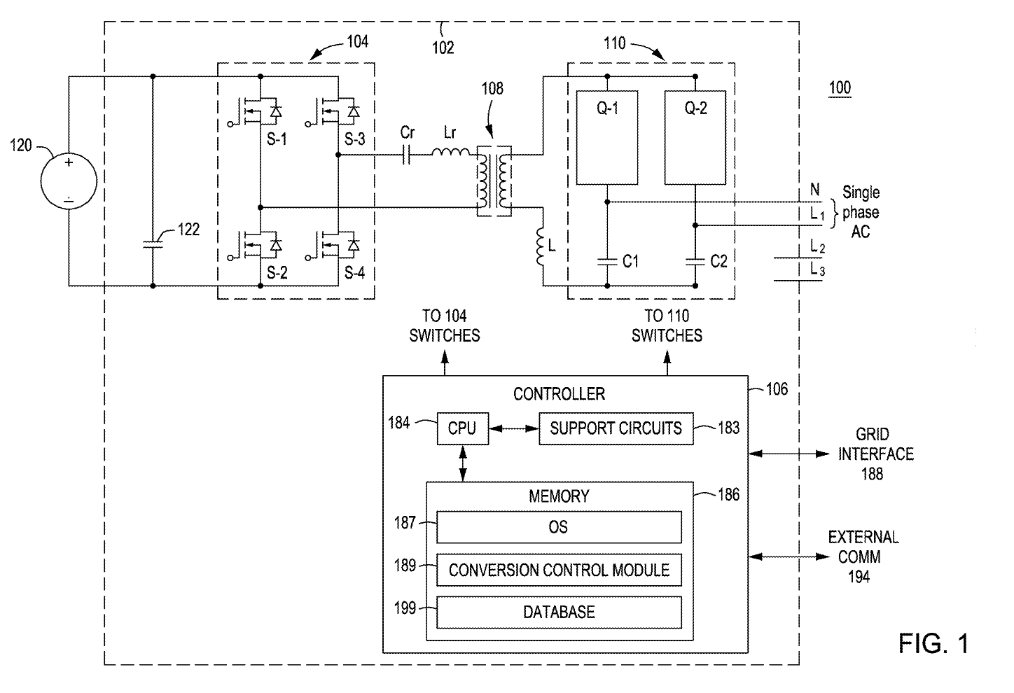

FIG. 1 is an example of an improved single-phase inverter with a three-phase droop response configured for use with a power conversion system 100 comprising a converter 102 (e.g., a switched mode power converter) in accordance with embodiments of the present disclosure.

The power conversion system 100 comprises a DC component 120 coupled to a DC side of the converter 102. The converter 102 comprises the capacitor 122 coupled across the DC component 120 and the H-bridge 104. The output of the H-bridge 104 is coupled across a series combination of the capacitor Cr and the inductor Lr, which form a resonant tank, and the primary winding of the transformer 108. In other embodiments, the resonant tank may be formed by a different configuration of the capacitor Cr and the inductor Lr (e.g., the capacitor Cr and the inductor L may be coupled in parallel); in some embodiments, Lr may represent a leakage inductance of the transformer 108 rather than a physical inductor.

A series combination of the secondary winding of the transformer 108 and the inductor L can be coupled across a bridge as described above with respect to FIG. 1. For example, the secondary winding of the transformer 108 and the inductor L can be coupled across a cycloconverter 110 which produces a single-phase AC output. For example, the cycloconverter 110 comprises two bi-directional switches Q-1 and Q-2, (collectively referred to as switches Q) respectively in a first leg and a second leg coupled in parallel to one another. In accordance with embodiments of the present disclosure, each of the switches Q-1 and Q-2 is a native four quadrant bi-directional switch comprising one or more of the aforementioned semiconductor (or vacuum tube) devices. Alternatively or additionally, the cycloconverter 110 can comprise two monolithically formed switches (e.g., a Monolithic Bi-Directional Switch (MBDS)) –Gallium-Nitride (GaN) based on a HEMT structure, as described in greater detail below. In at least some embodiments, each of the switches Q-1 and Q-2 comprises a pair of Gallium-Nitride (GaN) High Electron Mobility Transistors. In at least some embodiments, each of the switches Q-1 and Q-2 comprises a first pair of Gallium-Nitride (GaN) High Electron Mobility Transistors and a second pair of Gallium-Nitride (GaN) High Electron Mobility Transistors connected in series.

The first cycloconverter leg comprises the 4Q switch Q-1 coupled to the capacitor C1, and the second cycloconverter leg comprises the 4Q switch Q-2 coupled to the capacitor C2. A first AC output phase line is coupled between the switch Q-1 and the capacitor C1, and a second AC output phase line is coupled between the switch Q-2 and the capacitor C2. The converter 102 may also include additional circuitry not shown, such as voltage and/or current monitors, for obtaining data for power conversion, data reporting, and the like.

The converter 102 additionally comprises a controller 106 coupled to the H-bridge switches (S-1, S-2, S-3, and S-4), and the cycloconverter switches (Q-1 and Q-2) for operatively controlling the switches to generate the desired output power. In some embodiments, the converter 102 may function as a bi-directional converter.

The controller 106 comprises a CPU 184 coupled to each of support circuits 183 and a memory 186. The CPU 184 may comprise one or more conventionally available microprocessors or microcontrollers. Additionally or alternatively, the CPU 184 may include one or more application specific integrated circuits (ASICs). The support circuits 183 are well known circuits used to promote functionality of the CPU 184. Such circuits include, but are not limited to, a cache, power supplies, clock circuits, buses, input/output (I/O) circuits, and the like. The controller 106 may be implemented using a general purpose computer that, when executing particular software, becomes a specific purpose computer for performing various embodiments of the present disclosure.

The memory 186 is a non-transitory computer readable medium such as random access memory, read only memory, removable disk memory, flash memory, and various combinations of these types of memory. The memory 186 is sometimes referred to as main memory and may, in part, be used as cache memory or buffer memory. The memory 186 generally stores the OS 187 (operating system), if necessary, of the controller 106 that can be supported by the CPU capabilities. In some embodiments, the OS 187 may be one of a number of commercially available operating systems such as, but not limited to, LINUX, Real-Time Operating System (RTOS), and the like.

The memory 186 may store various forms of application software, such as a conversion control module 189 for controlling power conversion by the converter 102, for example maximum power point tracking (MPPT), switching, and the like. The memory 186 may further store a database 199 for storing various data. The controller 106 further processes inputs and outputs to external communications 194 (i.e., gateway) and the grid interface 188.

This invention disclosure presents a method to implement a three-phase droop law with a set of three single-phase inverters. The novelty is in the algorithms ability to transform a three-phase droop response into a signal phase actuation signal. In turn the single-phase actuation signals of three single-phase inverters collectively generate a three-phase droop response while on-grid. While off-grid, the 3-phase droop response will serve to enforce 120º phase shift between phases.

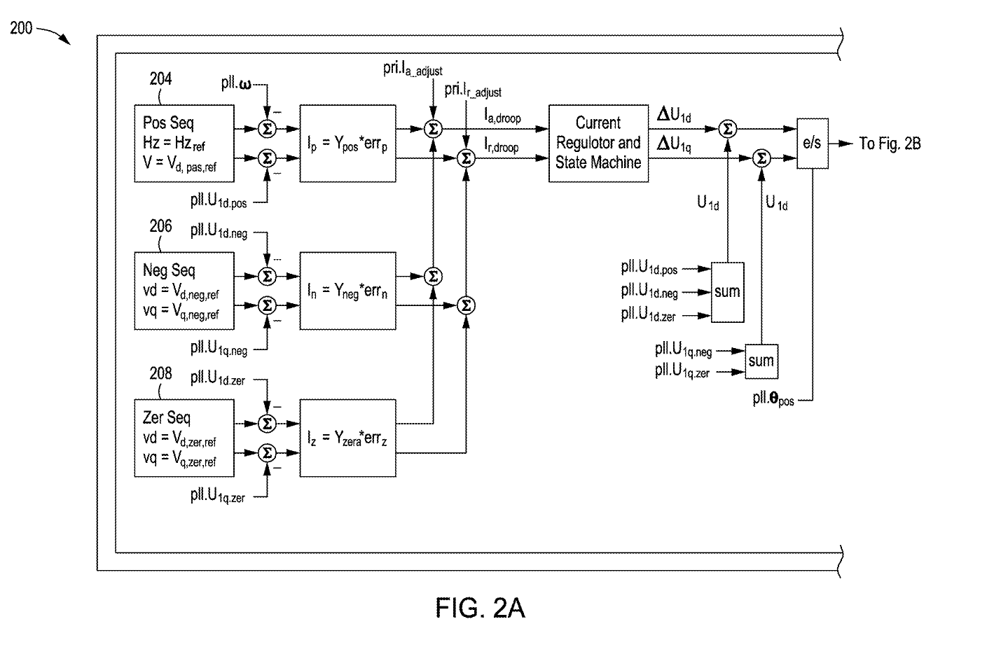

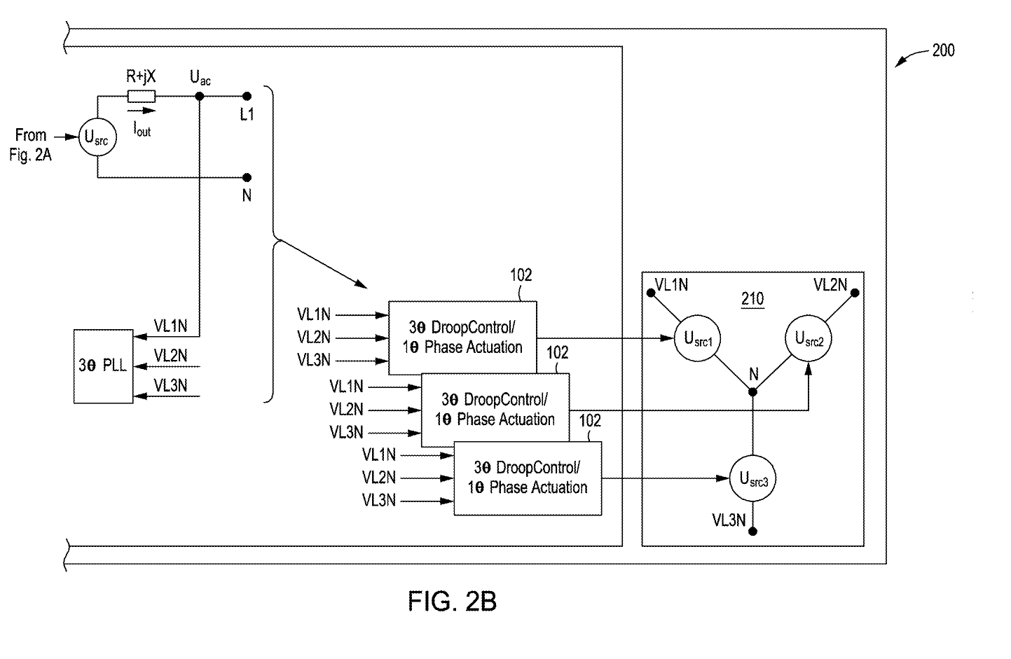

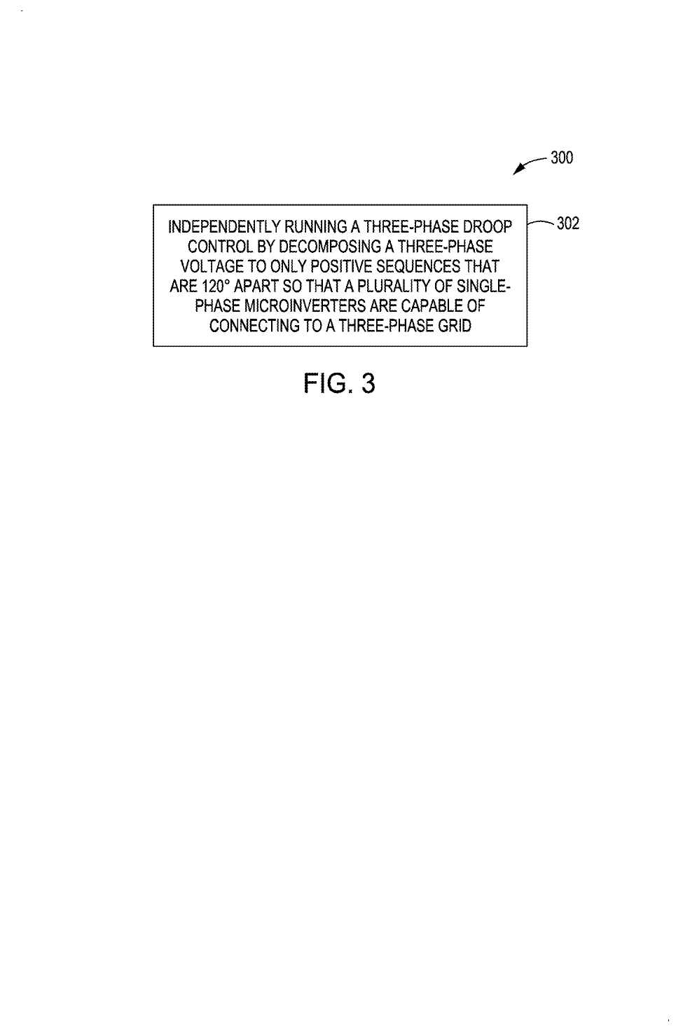

For example, FIGS. 2A and 2B are block diagrams 200 of a three-phase droop response configured for use with single-phase inverters (e.g., the converter 102 of FIG. 1), and FIG. 3 is a flowchart of a method in accordance with embodiments of the present disclosure.

For example, the block diagram 200 (FIG. 2A) illustrates a control algorithm 202 that decomposes a three-phase voltage into a positive sequence voltage 204, negative sequence voltage 206, and zero sequence voltage 208 by a three-phase phase locked loop (PLL). For example, in at least some embodiments, a plurality of single-phase microinverters (e.g., three single-phase microinverters, which can be connected in a three phase wye configuration) can each comprise a controller (e.g., the controller 106) configured to independently run a three-phase droop control by decomposing a three-phase voltage to only positive sequences that are 120º apart so that the plurality of single-phase microinverters are capable of connecting to a three-phase grid. The inventors have found that sequence decomposition allows for the independent control of each sequence voltage. For example, with respect to a three-phase voltage, the objective is to have 0 V for the negative sequence voltage 206 and zero sequence voltage 208. Thus, each inverter (e.g., three single-phase microinverters) runs the three-phase droop control which serves to drive the negative sequence voltage 206 and zero sequence voltage 208 towards 0 V. Thus, if a three-phase voltage is composed of only the positive sequence voltage 204, then the positive sequence voltage 204 vectors of each inverter will be 120° apart. Accordingly, each inverter independently decomposes the three-phase voltage and regulates a single-phase output to minimize the negative sequence voltage 206 and zero sequence voltage 208, thereby resulting in a set of three single-phase inverters (three of the converter 102) capable of forming a three-phase grid 210, e.g., via the grid interface 188. For example, a set of V_{L1N}, V_{L2N}, and VL_{3N} inputs are provided to each of three single-phase inverters and respective V_{L1N}, V_{L2N}, and V_{L3N} outputs are provided to the three-phase grid 210 (FIG. 2B).

While the foregoing is directed to embodiments of the present disclosure, other and further embodiments of the disclosure may be devised without departing from the basic scope thereof, and the scope thereof is defined by the claims that follow.

1. An apparatus configured for use with a power conversion system, comprising:
a plurality of single-phase microinverters, each single-phase microinverter of the plurality of single-phase microinverters comprises a controller configured to independently run a three-phase droop control by decomposing a three-phase voltage to only positive sequences that are 120º apart so that the plurality of single-phase microinverters are capable of connecting to a three-phase grid.

2. The apparatus of claim 1, wherein the plurality of single-phase microinverters comprises three single-phase microinverters.

3. The apparatus of claim 1, wherein each single-phase microinverter of the plurality of single-phase microinverters are connected in a three phase wye configuration.

4. The apparatus of claim 1, wherein each single-phase microinverter of the plurality of single-phase microinverters is configured to run the three-phase droop control by driving a negative sequence voltage and zero sequence voltage towards 0 V.

5. A power conversion system, comprising:
a plurality of single-phase microinverters, each single-phase microinverter of the plurality of single-phase microinverters comprises a controller configured to independently run a three-phase droop control by decomposing a three-phase voltage to only positive sequences that are 120º apart so that the plurality of single-phase microinverters are capable of connecting to a three-phase grid.

6. The power conversion system of claim 5, wherein the plurality of single-phase microinverters comprises three single-phase microinverters.

7. The power conversion system of claim 5, wherein each single-phase microinverter of the plurality of single-phase microinverters are connected in a three phase wye configuration.

8. The power conversion system of claim 5, wherein each single-phase microinverter of the plurality of single-phase microinverters is configured to run the three-phase droop control by driving a negative sequence voltage and zero sequence voltage towards 0 V.

9. A method of controlling an apparatus configured for use with a power conversion system, the method comprising:
independently running a three-phase droop control by decomposing a three-phase voltage to only positive sequences that are 120º apart so that a plurality of single-phase microinverters are capable of connecting to a three-phase grid.

10. The method of claim 9, wherein the plurality of single-phase microinverters comprises three single-phase microinverters.

11. The method of claim 9, wherein each single-phase microinverter of the plurality of single-phase microinverters are connected in a three phase wye configuration.

12. The method of claim 9, wherein each single-phase microinverter of the plurality of single-phase microinverters is configured to run the three-phase droop control by driving a negative sequence voltage and zero sequence voltage towards 0 V.
